(19) United States
(12) Patent Application Publication
(10) Pub. No.: US 2024/0369311 A1
(43) Pub. Date: Nov. 7, 2024

(54) HEATING AND/OR COOLING UNIT WITH PHASE-CHANGE MATERIAL

(71) Applicant: SUN-ICE ENERGY PTE. LTD., Singapore (SG)

(72) Inventor: Jacques Mouchet, Les Clayes-sous-Bois (FR)

(21) Appl. No.: 18/686,150

(22) PCT Filed: Aug. 24, 2022
(86) PCT No.: PCT/IB2022/057915

§ 371 Date: Feb. 23, 2024

(30) Foreign Application Priority Data
Aug. 24, 2021 (FR) FR2108875

(51) Int. Cl. F28D 20/02; F28D 20/00

(52) U.S. Cl. CPC F28D 20/021; F28D 2020/0078

(57) ABSTRACT

The present invention relates to a heating and/or cooling unit (1) for at least one thermal-control fluid (A), said unit (1) comprising at least one loop (3) in whicha heat-transfer fluid (F) flows, said loop (3) comprising: aphase-change material (5) configured to store energy; at least one heat exchanger (7) configured, on the one hand, for said heat-transfer fluid (F) to pass therethrough and, on the other hand, to cool or heat said storage material (5), characterised in that said heat exchanger (7) comprises a first structure in which a conduit for the heat-transfer fluid (F) is provided and a second structure surrounding the first structure, a space between said structures defining a housing in which said phase-change material (5) is disposed, the unit (1) being configured to cool or heat said thermal-control fluid (A) by means of the second structure of said exchanger.

The present invention relates to a heating and/or cooling unit comprising a phase-change material, in particular for the storage of energy.

For example, the invention is a complementary unit designed to integrate an existing heating and/or cooling installation, such as a reversible heat pump, etc.

Indeed, heating and/or cooling installations are extreme energy-consuming and environmentally unfriendly units and are the main sources of energy demand in towns. The present invention offers a solution to optimize the energy consumption and to take better care of the environment, while allowing the storage of calories or frigories (hence of heat or cold) when they are cheap or ecological, and to use them when needed, in particular in case of high demand and/or shortage periods (heat or cold waves, etc.).

A heating and/or cooling unit according to the invention is thus designed to store calories or frigories and deliver a fluid, such as air, at a desired temperature to regulate the temperature of a room, in particular of a housing, an office, a storage room, a meeting room, a cold room, etc.

Thus, the present invention is a heating and/or cooling unit for at least one thermal regulation fluid, said unit comprising at least a loop where a heat transfer fluid circulates, wherein said loop comprises:
a phase-change material configured to store energy (in particular thermal energy in a physicochemical form);
at least one heat exchanger configured, on one hand, for said heat transfer fluid to flow through it and, on the other hand, to cool or warm up said storage material;
characterized in that said heat exchanger comprises a first structure, where a conduit for the heat transfer fluid is arranged, with a second structure around the first structure, wherein said first and second structures are configured so that there is a gap between said structures that define a housing for said phase-change material, wherein the unit is configured to cool or warm up said thermal regulation fluid thanks to the second structure of said heat exchanger (and thanks to the phase-change material, in particular by extraction or heat transfer of said material).

The thermal regulation fluid can be air, for example, wherein warmed or cooled air makes it possible to thermally regulate some specific place.

It should be noted that a phase change material (PCM) is any material capable to change of physical state, in particular between a liquid state and a solid state, within a restricted range of temperature.

According to a possible characteristic, said loop comprises a shut-down valve, wherein said valve is configured to stop the circulation of the heat exchanger fluid through the loop of said unit. This shut-down valve is particularly useful at the shutdown of the unit and/or when the maximum energy storage is reached (which means when the phase-change material can no more store energy and there is some positive or negative evolution of its temperature beyond the latency time of said material).

According to the another possible characteristic, said unit comprises at least one means of circulation of said thermal regulation fluid, wherein said means of circulation is configured to circulate (preferably directly) said fluid along said heat exchanger (either at the center and/or at the edges of said exchanger). This geometry for the heat exchanger can be made, for example, by extrusion, in particular by extrusion of the central part of said heat exchanger.

According to the another possible characteristic, said unit comprises at least one pump to circulate the heat transfer fluid through said loop.

According to the another possible characteristic, the first structure and/or the second structure of said heat exchanger comprise fins.

It should be noted that the phase-change materials generally have a low coefficient of heat conductivity, fins that improve the thermal conduction between the phase-change material and the other parts of the exchanger and with the heat transfer fluid and/or the thermal regulation fluid, such as an air flow.

According to the another possible characteristic, the fins of the first structure extend away toward the second structure of said heat exchanger.

In other words, the fins of the first structure extend from the first structure toward the second structure of said heat exchanger.

According to the another possible characteristic, the fins of the second structure extend away from the second structure and/or toward the first structure.

According to the another possible characteristic, the heat exchanger comprises two aluminum extruded profiles that are positioned concentric relatively to each another. The first extruded profile, respectively the first structure, comprises the conduit of the heat transfer fluid at its center, while the second extruded profile, respectively the second structure, comprises fins at its outer surface to transfer or yield calories to the thermal regulation fluid, such as ventilation air, while the phase-change material between the two profiles, for example, is maintained at the latent temperature of fusion of said material (for example a latent temperature of fusion between 22 and 24° C.).

According to the another possible characteristic, said heat exchanger is positioned inside a sheath, wherein the gap between the inner surface of the sheath and the second structure of said heat exchanger defines a conduit for the thermal regulation fluid.

According to the another possible characteristic, said unit comprises at least one sensor of the following types: a temperature sensor for the heat transfer fluid into and/or out of said heat exchanger, a temperature sensor for the phase-change material, a temperature sensor for the air flow into and/or out of said heat exchanger (or of the unit), a temperature sensor for the room that is thermally conditioned by said unit, a relative moisture sensor, a carbon dioxide sensor.

It should be noted that the relative moisture sensor and/or the carbon dioxide sensor are facultative and are used, inter alia, to optimize the function of the unit in tropical countries and to minimize the use of outer air. The carbon dioxide sensor is also a security feature that prevents the rate of carbon dioxide of the room conditioned by said unit from reaching value that may be detrimental or harmful for the human health.

According to the another possible characteristic, said unit is configured to interface with or integrate with an air-conditioning and/or heating installation, in particular a system that works thanks to a heat transfer fluid and/or a hot refrigerant fluid and/or that is refrigerated.

According to the another possible characteristic, said unit comprises a management electronic entity configured to monitor, inter alia, the circulation of the heat transfer fluid through said loop and/or the circulation of the thermal regulation fluid. In particular, the entity allows the storage of energy in the phase-change material during off-peak time and restrict its consumption when the energy is more expensive.

According to the another possible characteristic, said unit comprises a human-machine interface. The present invention also refers to a heating and/or air-conditioning installation comprising a heating and/or air-conditioning unit such as defined above.

The invention shall be better understood, and other goals, details, features and advantages shall appear more clearly in the following description of specific embodiments of the invention, which are introduced only for information and non-restrictively, with reference to the appended picture, where:

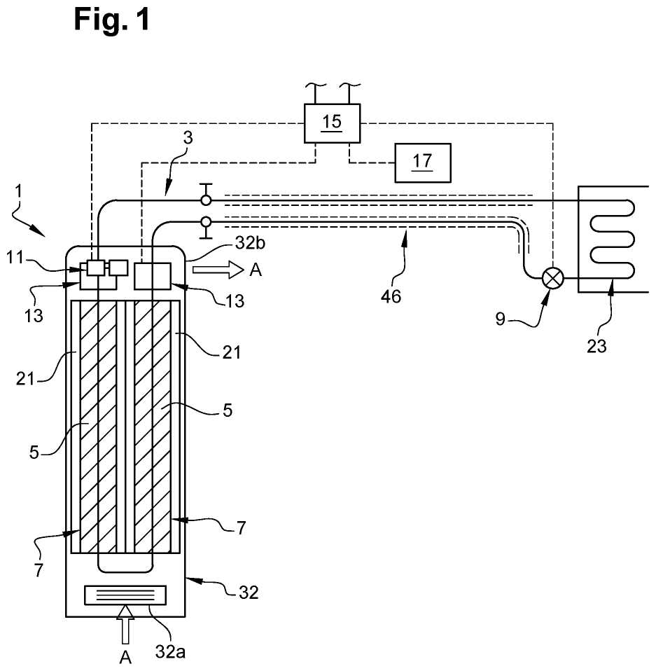

FIG. 1, referenced as [FIG. 1], is a very schematic view of a heating and/or air-conditioning unit according to the invention;

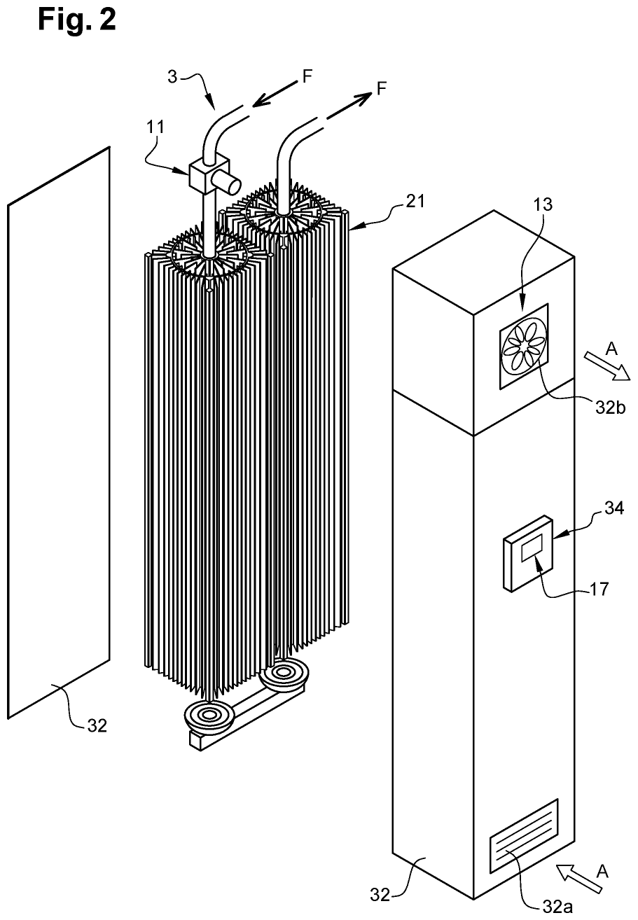

FIG. 2, referenced as [FIG. 2], is an enlarged perspective view of a part of the unit of FIG. 1;

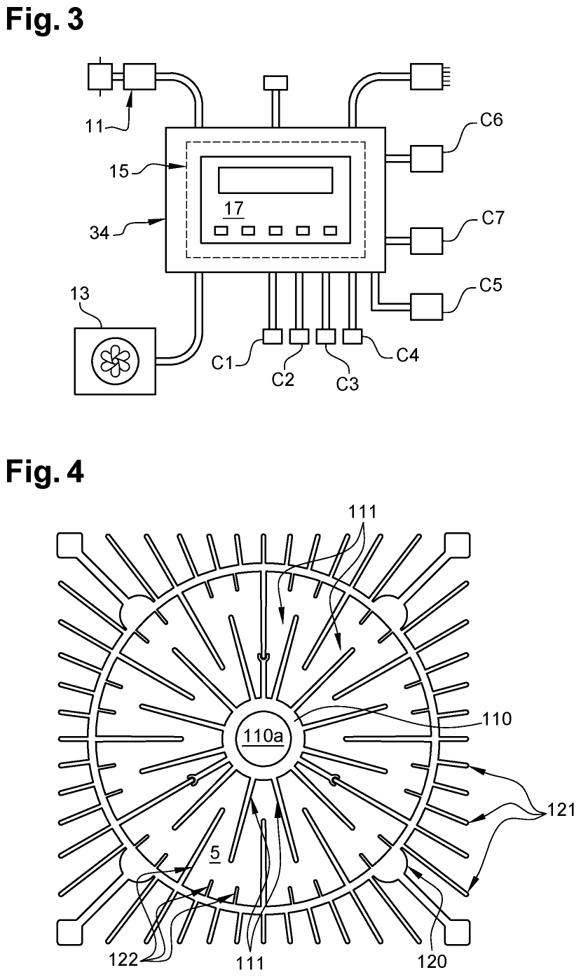

FIG. 3, referenced as [FIG. 3], is an enlarged perspective view of the control case of the unit of FIGS. 1 and 2;

FIG. 4, referenced as [FIG. 4], is a cross-section of the heat exchanger of the unit of FIG. 1;

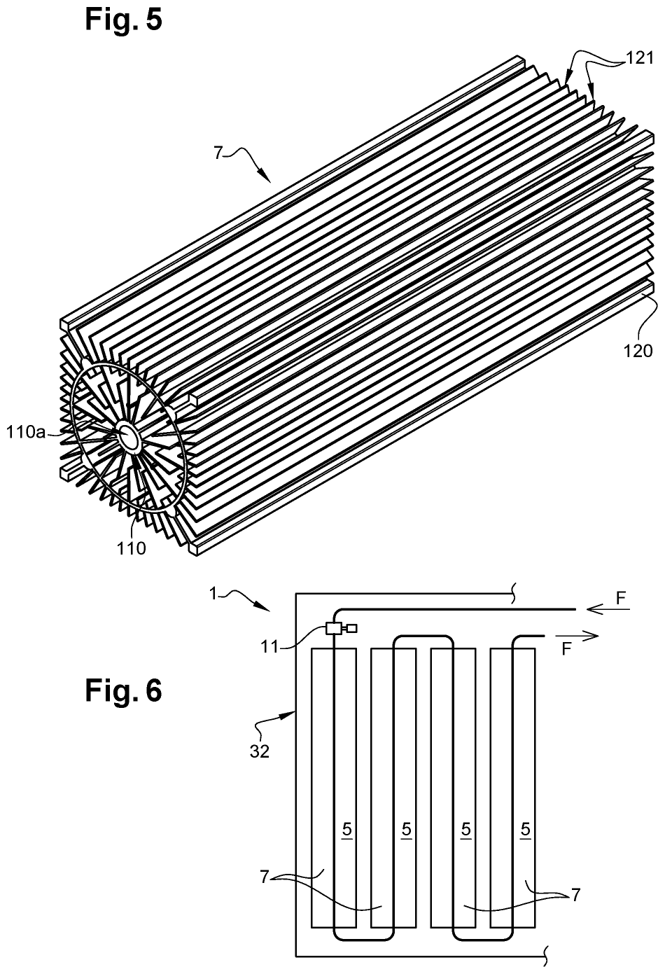

FIG. 5, referenced as [FIG. 5], is a perspective view of the heat exchanger of the unit of FIG. 1;

FIG. 6, referenced as [FIG. 6], is a schematic view of a part of the unit according to a variant of embodiment of the invention.

FIG. 1 is thus a very schematic view of a heating and/or air-conditioning unit 1 according to the invention, while FIG. 2 is an enlarged perspective view of a part of the unit 1 of FIG. 1.

The heating and/or cooling unit 1 is configured to warm up and/or cool at least a thermal regulation fluid A, such as air, designed to regulate the temperature of a room (housing, office, etc.).

Thus, said unit 1 comprises at least one loop 3 through which a heat transfer fluid F circulates. Said loop 3 comprises:
a phase-change material 5, which means a material able to change of physical state in a restricted temperature range and to store and release calories this way;
at least one heat exchanger 7 configured, on one hand, for said heat transfer fluid F to flow through it and, on the other hand, to cool or warm up said phase-change material.

Said phase-change material 5 has a fusion temperature between −10° C. and 25° C. (for the storage of energy), preferably between −5° C. and 20° C., and even more preferably between 22° C. and 24° C., in particular if said fluid is designed for the thermal regulation of a room that is compatible with the standards of human comfort.

Thus, said loop 3 comprises:
At least one pump 9 to circulate the heat transfer fluid F through said loop 3.
The shut-down valve 11, said valve 11 being configured to stop the circulation of the heat transfer fluid F through the loop 3 of said unit 1. Shutting down the circulation of the heat transfer fluid F restricts or stops the storage or release of calories between the heat transfer fluid F and the phase-change material 5.
At least one means of circulation 13 of said thermal regulation fluid A, wherein said means of circulation 13 is configured to circulate said fluid A along said heat exchanger 7.

It should be noted that the heat transfer fluid F is advantageously water, water glycol (which means a mixing of water and glycol), glycol, etc.

The means of circulation 13 is, for example, a fan-motor assembly or a fan (i.e. a centrifugal fan) that makes it possible to suck (or “push”) air A through the unit 1 and circulate the air along the heat exchanger 7 so that it cools or warms up thanks to it (and by extension the room where the air flows in). According to not pictured embodiments, the heat exchanger can have different geometries and/or comprise various items so that air can flow at the center and/or at the edges of said heat exchanger.

The speed of said means of circulation 13 is advantageously monitored, for example to reduce the noise of the ventilation at night and/or to regulate the temperature of the thermal regulation fluid (thanks to the monitoring of the flowrate of the fluid out of the room to regulate thermally).

As specifically illustrated at FIGS. 1 and 2, the unit 1 comprises a case 32 where are located, for example, the heat exchanger 7, the means of circulation 13, a part of the loop 3, the shut-down valve 11, etc. Said case 32 also comprises an air inlet 32a and an air outlet 32b to allow the air circulation thanks to the means of circulation 13. Furthermore, it should be noted that the air inlet 32a can be configured to suck air from the outside (generally dry) and/or air already thermally conditioned by the unit (also called recycled air).

Advantageously, a part of the loop 3 that is not in the case 32 is thermally isolated from the outside, for example thanks to a thermal insulation 46. This thermal insulation restricts thermal losses before the heat transfer fluid reaches the phase-change material (this is all the more relevant than the loop is big out of the case).

It should be noted that the unit 1 is configured to be linked to a heating and/or air-conditioning installation, a heat pump, etc. or to any other device that generates cold or heat (generally units that work on a thermodynamic cycle).

In the embodiment of FIG. 1, the loop 3 of the unit 1 comprises an additional heat exchanger 23 configured to create such a link with a hot and/or cold source, hence to easily couple the unit 1 to an existing heating and/or air-conditioning installation.

Said unit 1 also comprises:
At least one sensor (more specifically visible at FIG. 3) of the following types: a temperature sensor for the heat transfer fluid into and/or out of said heat exchanger C1 and/or C2, a temperature sensor for the phase-change material C3, a temperature sensor for the air flow into and/or out of said heat exchanger C4, a temperature sensor for the room C5 that is thermally conditioned by said unit, a relative moisture sensor C6, a carbon dioxide sensor C7.
A management electronic entity 15 configured to monitor, inter alia, the circulation of the heat transfer fluid F through said loop 3 and/or the circulation (flow, speed, etc.) of the thermal regulation fluid A through the unit 1.
A human-machine interface 17, said human-machine interface (or user interface) being all the items that allow the user to interact with the unit, more specifically to monitor the unit and/or to exchange information with it. The human-machine interface comprises, for example, one or several of the following items: button(s), keyboard, screen, touchscreen, knob(s), indicator lights, etc.

In addition, the management electronic entity 15 and the human-machine interface 17 are advantageously located in a control case 34. The case 34 and the various sensors C1 to C7 are more specifically illustrated at FIG. 3.

Furthermore, the entity 15 advantageously comprises:
An Internet connection means, in particular to recover data relative to weather forecasts and so being able to preview temperature changes and consequently store or release calories with the phase-change material;
A connection means to one or several other units according to the invention, to make it possible for them to work in cooperation, in particular by allowing one of them to monitor all the other units.

As pictured at FIG. 2, said heat exchanger 7 is preferably located in a sheath 21. Said sheath 21 is preferably made of a thermally isolating material.

As more specifically illustrated at FIGS. 4 and 5, which are respectively a cross-section view and a perspective view of the heat exchanger 7, this heat exchanger 7 comprises:
A first structure 110 where a conduit 110a is designed for the heat transfer fluid F, for example at the center;
A second structure 120 around the first structure 110 (hence around the conduit 110a), for example concentric relatively to the first structure 110.

Said first 110 and second 120 structures are configured so that there is a gap between said structures 110 and 120 that define a housing where the phase-change material 5 is positioned (or stored).

Furthermore, it should be noted that the heat exchanger 7 and its first and second structures 110 and 120 are advantageously made of a metallic thermally conductive material, such as aluminum.

The heat exchanger 7 is advantageously manufactured by extrusion. The heat exchanger 7 has preferably an elongated shape, so that the conduit for the heat transfer fluid is as long as possible, thus yielding to or recovering calories from the phase-change material.

Thus, according to a possible embodiment, the heat exchanger 7 comprises two aluminum extruded profiles 110 and 120 that are positioned concentric relatively to each another. For example, each of the profiles has circular, square, rectangle cross-sections, etc. The first extruded profile, resp. the first structure 110, comprises at its center the conduit 110a of the heat transfer fluid.

Thus, the thermal regulation fluid A is cooled and/or warmed thanks to the second structure 120 of said heat exchanger 7, in particular through its outer surface.

In addition, the structures 110 and 120 advantageously comprise fins 111, 121 and 122, wherein said fins increase the contact surfaces, thus maximize thermal exchanges.

In particular, the fins 111 of the first structure 110 extend away toward the second structure 120 of said heat exchanger 7, thus the fins 111 extend into the volume or space where the phase-change material 5 is stored, which increases the contact surface between said material 5 and the first structure 110, and promotes thermal exchanges between the heat transfer fluid F through the conduit 110a and said material 5.

On the other hand, the fins 121 and 122 of the second structure 120 can extend away from the second structure 120 (from its outer surface)—they will be called external fins 121—and/or extend toward the first structure 110 (from the inner surface of the structure 120)—they will be called internal fins 122. External fins 121 increase the contact surface between the thermal regulation flow A and the second structure 120, which promotes thermal exchanges, while internal fins 122 increase the contact surface between the phase-change material 5, which promotes thermal transfer between the material 5 and the thermal regulation flow A.

It should be noted that some fins 111 of the first structure 110 and the internal fins 122 are configured to cooperate with each other to secure a constant gap between said structures 110 and 120 and a good mechanical resistance of the set.

It should also be noted that the sheath 21 specifically encircles said at least one heat exchanger 7 so that there is a gap between the inner surface of the sheath 21 and the second structure 120 of said heat exchanger 7, wherein the gap created this way defines a conduit for the thermal regulation fluid A and makes it possible to channel it and maximize thermal exchanges between the fluid A and the heat exchanger 7.

Advantageously, the outer perimeter defined by the external fins 121 has a geometric shape, such as a square or rectangle shape, which makes the manufacture easier for a sheath 21 to put onto the heat exchanger 7.

In an embodiment as pictured on FIG. 6, the unit 1 comprises several heat exchangers 7 mounted serially and/or in parallel, wherein each heat exchanger 7 can comprise phase-change materials 5 with different latent temperatures of fusion. In particular, this configuration provides greater versality in terms of the external temperature conditions and of the temperatures that the unit according to the invention must submit the thermal regulation fluid to.

The present invention also refers to a heating and/or air-conditioning installation comprising a heating and/or air-conditioning unit such as defined above.

1. A heating and/or cooling unit for at least one thermal regulation fluid said unit comprising at least a loop where a heat transfer fluid circulates, wherein said loop comprises:
a phase-change material configured to store energy;
at least one heat exchanger configured, on one hand, for said heat transfer fluid to flow through it and, on the other hand, to cool or warm up said storage material;
characterized in that said heat exchanger comprises a first structure, where a conduit for the heat transfer fluid is arranged, with a second structure around the first structure, wherein said first and second structures are configured so that there is a gap between said structures that define a housing for said phase-change material, wherein the unit is configured to cool or warm up said thermal regulation fluid thanks to the second structure of said heat exchanger.

2. A unit according to claim 1, characterized in that it comprises at least one means of circulation of said thermal regulation fluid, wherein said means of circulation is configured to circulate said fluid along said heat exchanger.

3. A unit according to claim 1, characterized in that it comprises at least one pump to circulate the heat transfer fluid through said loop.

4. A unit according to claim 1, characterized in that the first structure and/or the second structure comprise fins.

5. A unit according to claim 4, characterized in that the fins of the first structure extend away toward the second structure of said heat exchanger, and/or the fins of the second structure extend away from the second structure and/or extend toward the first structure.

6. A unit according to claim 1, characterized in that said heat exchanger is positioned inside a sheath, wherein the gap between the inner surface of the sheath and the second structure of said heat exchanger defines a conduit for the thermal regulation fluid.

7. A unit according to claim 1, characterized in that it comprises at least one sensor of the following types: a temperature sensor for the heat transfer fluid, a temperature sensor for the phase-change material, a temperature sensor for the air flow into and/or out of said heat exchanger, a temperature sensor for the room that is thermally conditioned by said unit, a relative moisture sensor, a carbon dioxide sensor.

8. A unit according to claim 1, characterized in that said unit is configured to interface with or integrate with an air-conditioning and/or heating installation.

9. A unit according to claim 1, characterized in that it comprises a management electronic entity configured to monitor, inter alia, the circulation of the heat transfer fluid through said loop and/or the circulation of the thermal regulation fluid.

10. A heating and/or air-conditioning installation comprising a heating and/or air-conditioning unit according to claim 1.
